(19) United States
(12) Patent Application Publication
(10) Pub. No.: US 2010/0265145 A1
(43) Pub. Date: Oct. 21, 2010

(54) INTEGRATED ANTENNA SYSTEM FOR CAR AND METHOD OF MAKING SAME

(75) Inventor: Tae Inn Chung, Gyeongsangbuk-do (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/605,477

(22) Filed: Oct. 26, 2009

(30) Foreign Application Priority Data
Apr. 19, 2009 (KR) 10-2009-0033772

(51) Int. Cl. H01Q 1/32; H01Q 1/36; H01P 11/00

(52) U.S. Cl. 343/713; 29/600; 343/895

(57) ABSTRACT

An integrated antenna system for a car and a manufacturing method thereof are provided. The system includes: a base in which a first antenna and an antenna reception circuit installed; and a support which is installed in an upper portion of the base and implemented in a form of cylinder or polygonal barrel in such a manner that the antenna reception circuit and the first antenna are located in the inside thereof, wherein a second antenna is wound up in a spiral form on an inner and/or outer circumference of the support. The system provides a greater degree of freedom of design without reducing performance of the antenna system.

### CROSS-REFERENCE TO RELATED APPLICATION

This application claims under 35 U.S.C. §119(a) the benefit of Korean Patent Application No. 10-2009-0033772 filed Apr. 19, 2009, the entire contents of which are incorporated herein by reference.

### BACKGROUND

1. Technical Field

The present disclosure relates to an integrated antenna system for car and making method thereof.

2. Background Art

FIG. 1 is a perspective view of a conventional integrated antenna system for a car. As shown in FIG. 1, the conventional integrated antenna system (so-called ‘Shark Antenna’) includes a helical antenna 110 for receiving a FM/AM signal and a DMB signal, a monopole antenna 120 for receiving a HSDPA signal, and a GPS antenna 130 for receiving a GPS signal which are integrated. The helical antenna 110 is usually arranged at an incline for the purpose of optimizing reception sensitivity and ensuring maximum distance.

One of the problems associated with the conventional integrated antenna system, however, is that the size of the integrated antenna system cannot be reduced enough to guarantee the reception sensitivity of the helical antenna.

Another problem is that the degree of freedom in design of such integrated antenna system is quite limited since the system has to be manufactured in a shark form with a long incline at which the helical antenna is installed.

The above information disclosed in this the Background section is only for enhancement of understanding of the background of the invention and therefore it may contain information that does not form the prior art that is already known in this country to a person of ordinary skill in the art.

### SUMMARY

In one aspect, the present invention provides an integrated antenna system for a car including a first antenna and a second antenna, which comprises: a base in which the first antenna and an antenna reception circuit installed; and a support which is installed in an upper portion of the base and implemented in a form of cylinder or polygonal barrel in such a manner that the antenna reception circuit and the first antenna are located in the inside thereof, wherein the second antenna is wound up in a spiral form on an inner circumference of the support, an outer circumference thereof, or both.

In another aspect, the present invention provides a method of manufacturing an integrated antenna system for a car including a first antenna and a second antenna, which comprises: (a) installing the first antenna and an antenna reception circuit in a base; (b) installing a support implemented in a form of cylinder or polygonal barrel in an upper portion of the base in such a manner that the antenna reception circuit and the first antenna are located in the inside thereof; and (c) winding up the second antenna in a spiral form on an inner circumference of the support, an outer circumference thereof, or both.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not imitative of the present invention, and wherein:

FIG. 1 is a perspective view of a conventional integrated antenna system for a car;

FIG. 2 is a perspective view for an integrated antenna system for a car according to an embodiment of the present invention;

FIG. 3 is a graph which compares directivity of the GPS antenna of an integrated antenna system according to an embodiment of the present invention with that of the GPS antenna of a conventional shark antenna;

FIG. 4 is a graph which compares directivity of the HSDPA antenna of an integrated antenna system according to an embodiment of the present invention with that of the HSDPA antenna of a conventional shark antenna;

FIG. 5 is a graph which compares reception sensitivity of the helical antenna of an integrated antenna system according to an embodiment of the present invention with those of the helical antenna of a conventional shark antenna; and

FIG. 6 is a graph which compares reception sensitivity of the DMB antenna of an integrated antenna system according to an embodiment of the present invention with those of the DMB antenna of a conventional shark antenna.

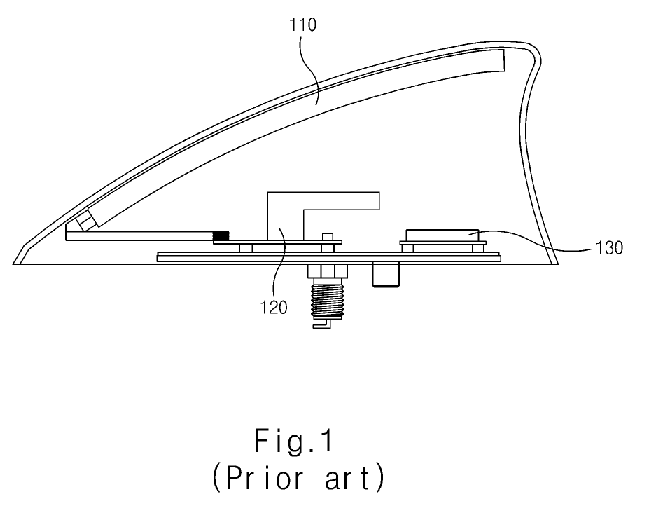

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter, exemplary embodiments of the present invention will be described in detail with reference to the attached drawings

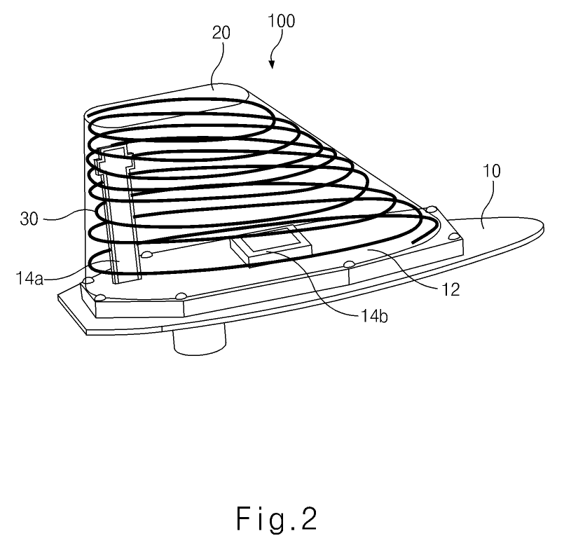

FIG. 2 is a perspective view of an integrated antenna system 100 for a car according to an embodiment of the present invention.

As shown in FIG. 2, the integrated antenna system 100 includes a base 10, a support 20, and a second antenna 30.

The base 10 may be a panel. A printed circuit board 12, a first antenna 14a, 14b, and an antenna reception circuit (not shown) are installed in the upper portion of the panel. The printed circuit board 12 is deposited in the upper portion of the base 10, while the first antenna 14a, 14b, the second antenna 30, and the reception circuit (not shown) are mounted in the printed circuit board 12. Preferably, the first antenna 14a, 14b, includes the monopole antenna 14a for receiving HSDPA or CDMA in one side and the GPS antenna 14b for receiving GPS in the other side. An amplifier circuit of the first antenna 14a, 14b and the second antenna 30 is mounted in the reception circuit (not shown).

The support 20 is installed in the upper portion of the base 10. Preferably, it is made of a dielectric substance of epoxy material. Also preferably, it is made in a form of, e.g., cylinder or polygonal barrel in such a manner that the reception circuit and the first antenna 14a, 14b are located inside the support 20. Here, at least one spiral groove is formed on the inner and/or outer circumference of the support 20.

The second antenna 30 is wound up in the spiral groove or grooves of the support 20. The second antenna 30 is configured with a helical antenna of copper material for receiving FM/AM or DMB signals. By inserting and fixing the second antenna 30 in the groove(s), the second antenna 30 is prevented from being separated from the support 20.

Meanwhile, the antenna system may further include a cover (not shown), in a similar shape as the support 20, that can shut the upper portion of the support 20 tightly and can be fixed on the base 10.

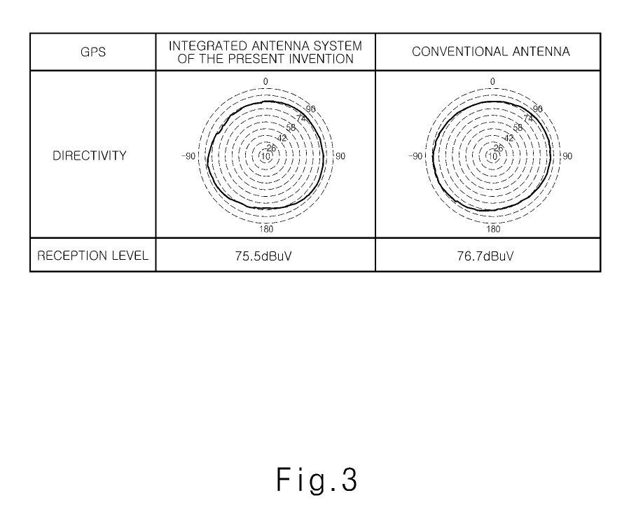

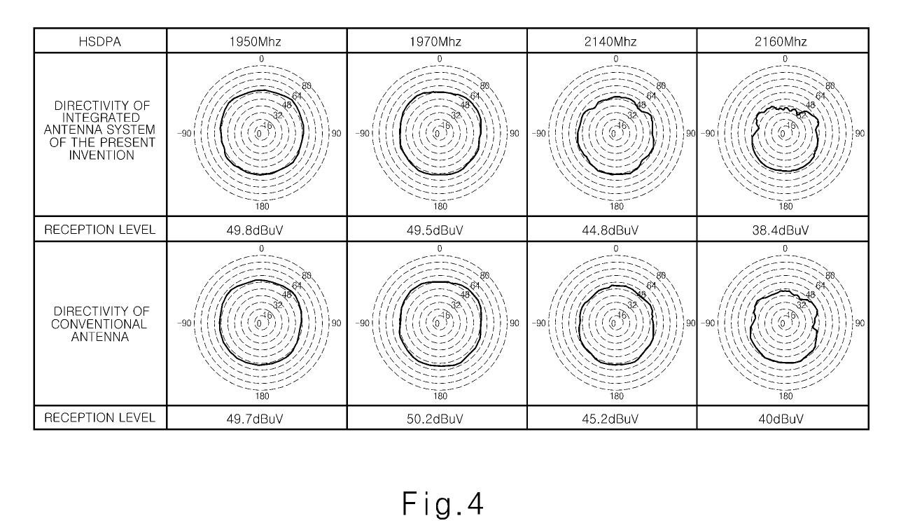

FIG. 3 is a graph which compares directivity of the GPS antenna of an integrated antenna system according to an embodiment of the present invention with that of the GPS antenna of a conventional shark antenna. FIG. 4 is a graph which compares directivity of the HSDPA antenna of an integrated antenna system according to an embodiment of the present invention with that of the HSDPA antenna of a conventional shark antenna.

As shown in FIG. 3, the directivity of the GPS antenna of the present integrated antenna system is 76.7 [dBuV], and the directivity of the GPS antenna of a conventional shark antenna is 75.5 [dBuV]. The values of the directivity are almost same. Also, as shown in FIG. 4, in a range of 1950 Mhz-2160 Mhz bandwidth, the directivity of the HSDPA antenna of the present integrated antenna system is 49.8 [dBuV]-38.3 [dBuV], and the directivity of the HSDPA antenna of a conventional shark antenna is 49.7 [dBuV]-40.00 [dBuV]. The values of the directivity are almost same as well.

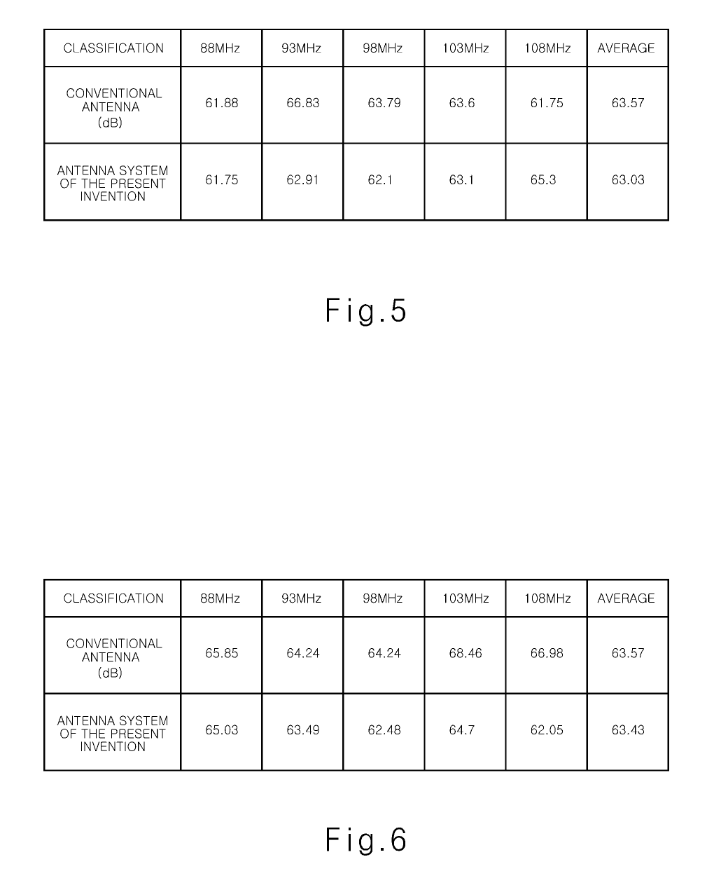

FIG. 5 is a graph which compares reception sensitivity of the helical antenna of an integrated antenna system according to an embodiment of the present invention with those of the helical antenna of a conventional shark antenna. FIG. 6 is a graph which compares reception sensitivity of the DMB antenna of an integrated antenna system according to an embodiment of the present invention with those of the DMB antenna of a conventional shark antenna.

As shown in FIG. 5, in a range of radio 88 Mhz-108 Mhz bandwidth, reception sensitivity of the helical antenna of the present integrated antenna system is 63.03 [dBuV] in average, and reception sensitivity of the helical antenna of a conventional shark antenna is 63.57 [dBuV]. The values of reception sensitivity are almost same. Furthermore, as shown in FIG. 6, in a range of 177 Mhz-213 Mhz bandwidth, reception sensitivity of the DMB antenna of the integrated antenna system 65.68 [dBuV] in average, and reception sensitivity of the DMB antenna of a conventional shark antenna is 63.43 [dBuV]. The values of reception sensitivity are almost same.

As described above, the present integrated antenna systems can reduce the weight of a final product and increase the degree of freedom of design, while retaining almost the same reception sensitivity and directivity with those of conventional shark antennas.

Hereinafter, an exemplary manufacturing method of the integrated antenna system is described.

Firstly, the first antenna and the antenna reception circuit are set on the base (S100). Then, the support in a form of cylinder or polygonal barrel is set in the upper portion of the base in such a manner that the antenna reception circuit and the first antenna are located inside the support (S102). The second antenna is wound up in a spiral form around the inner and/or outer circumference of the support (S103). Preferably, the second antenna may be wound up in a groove or grooves provided on the inner and/or outer circumference of the support.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An integrated antenna system for a car including a first antenna and a second antenna, the integrated antenna system comprising:
a base in which the first antenna and an antenna reception circuit installed; and
a support which is installed in an upper portion of the base and implemented in a form of cylinder or polygonal barrel in such a manner that the antenna reception circuit and the first antenna are located in the inside thereof,
wherein the second antenna is wound up in a spiral form on an inner circumference of the support, an outer circumference thereof, or both.

2. The integrated antenna system of claim 1, wherein at lest one groove is formed on an inner circumference of the support, an outer circumference thereof, or both so that the second antenna is inserted thereto and fixed therein.

3. The integrated antenna system of claim 1, wherein the second antenna includes a helical antenna for receiving FM/AM or DMB.

4. The integrated antenna system of claim 1, wherein the first antenna includes at least one monopole antenna for receiving HSDPA or CDMA, at least one GPS antenna for receiving GPS, or both.

5. The integrated antenna system of claim 1, wherein the support is made of a dielectric substance of epoxy material.

6. A method of manufacturing an integrated antenna system for a car including a first antenna and a second antenna, the method comprising:
(a) installing the first antenna and an antenna reception circuit in a base;
(b) installing a support implemented in a form of cylinder or polygonal barrel in an upper portion of the base in such a manner that the antenna reception circuit and the first antenna are located in the inside thereof; and
(c) winding up the second antenna in a spiral form on an inner circumference of the support, an outer circumference thereof, or both.

7. The integrated antenna system of claim 6, wherein, in step (a), at least one groove is formed is formed on an inner circumference of the support, an outer circumference thereof, or both so that the second antenna is inserted thereto and fixed therein.

8. The integrated antenna system of claim 6, wherein the second antenna includes a helical antenna for receiving FM/AM or DMB.

9. The integrated antenna system of claim 6, wherein the first antenna includes at least one monopole antenna for receiving HSDPA or CDMA, at least one GPS antenna for receiving GPS, or both.

10. The integrated antenna system of claim 6, wherein the support is made of a dielectric substance of epoxy material.
